(19) United States
(12) Patent Application Publication
(10) Pub. No.: US 2007/0215138 A1
(43) Pub. Date: Sep. 20, 2007

(54) ELECTRIC CONCRETE CUTTING CHAIN SAW

(75) Inventors: James L. Vanderzanden, Sherwood, OR (US); Kent M. Johnston, Lake Oswego, OR (US); Ian S. Osborne, Hillsboro, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: BLOUNT, INC., Portland, OR (US)

(21) Appl. No.: 11/694,604

(22) Filed: Mar. 30, 2007

Related U.S. Application Data
(63) Continuation-in-part of application No. 10/940,294, filed on Sep. 13, 2004, now abandoned.
(60) Provisional application No. 60/887,334, filed on Jan. 30, 2007.

(51) Int. Cl. B28D 1/08

(52) U.S. Cl. 125/21

(57) ABSTRACT

A concrete cutting chain saw has heretofore been considered a rugged performing tool demanding high horsepower and unavailable to the homeowner having only single phase electrical power for powering such a tool. This has been addressed and resolved by a balancing of the torque and chain speed to thereby allow for sufficient torque at the lower horsepower capability of single phase power inputs. Chain width and thereby cutting width may also be reduced, as well as the abrasive elements per cutter may be reduced in order to enable the use of low horsepower power heads.

### PRIORITY INFORMATION

This application is a continuation in part of non provisional patent application Ser. No. 10/940,294 filed Sep. 13, 2004, and further claims priority to provisional patent application No. 60/887,334, filed Jan. 30, 2007.

### FIELD OF THE INVENTION

This invention relates to the provision of a concrete cutting chain saw that can be powered by conventional single phase household electric power balancing a combination of chain speeds and torques to achieve appreciable cutting on lower horsepower power heads (e.g. power heads with a limited power input).

### BACKGROUND OF INVENTION

Historically, concrete cutting saws have been diamond impregnated circular blade cutting saws. Such saws require large circular blades, e.g. a 16″ in diameter blade that has a maximum cutting depth of e.g. 6″. Further, a configuration of a cut made by the circular saw blade is curved with a shallow lead in cut and a shallow exit cut. Thus, a through cut of e.g. 10″ will require a shallow lead in and shallow exit cut that extends beyond the 10″ through cut, at both ends, by several inches.

These and other factors have prompted the development of a chain saw type concrete cutting saw. The configuration of the cut can be made square and thus provide a clean cutout of a square or rectangular shape as may be desired, e.g., for providing a window or door opening in a concrete wall.

Conventional thinking has taught that the higher the horsepower the more rugged and longer lived the cutting tool and the greater the ability to cut the concrete. Thus, for a professional user who engages in major day after day cutting, a very high horsepower power source is required, such as up to 30 horsepower motor. Such units may cost in the order of $8,000 or more. A semi professional user may be able to achieve the speed and torque necessary with a 6 to 7 horsepower motor, and a contractor, with less frequent need for such a tool, may be able to use a 4.5 to 6 horsepower motor. All of these motors are considered high horsepower, and not suitable for operating off a typical single phase household current, but require a three phase power source provided, for example, by a generator.

A concrete chain saw has several concerns. The chain is comprised of alternating center drive links and pairs of opposing side links. Certain or all of the paired side links cooperatively carry a cutting head including a matrix block impregnated with diamond chips. This arrangement requires a thicker cut to accommodate the triple width thickness of center and side links as compared to the single thickness of a circular blade. In any event, concrete cutting chain saws have been considered to require a substantial drive motor requiring high horsepower inputs, e.g. ranging from a low of about 5 horsepower motors to as high as greater than 9 horsepower motors. Motors having such substantial horsepower are primarily hydraulic and gas motors, with some at the low end of the power requirements driven by an industrial electric motor, i.e., that requires the use of a separate generator and cannot be simply plugged into a household electric outlet.

The horsepower of a cutting head relates to torque and cutter speed in concrete cutting saws. For cutting concrete the prevailing view has been that the cutter speed must be maintained at an established level (generally lower) in order to achieve the necessary torque for acceptable concrete cutting applications. At the desired level of surface speed, the power source must be of a sufficient horsepower in order to generate a minimum level of torque, i.e., as necessary to drive the chain at the desired speed while cutting through the concrete. Heretofore the speed and torque considered necessary has eliminated the use of household electrical power as a power source for concrete cutting saws, and has required the use of high horsepower power heads.

An example of such a high horsepower concrete cutting chain saw is disclosed in U.S. Pat. No. 3,593,700 issued to McNulty. McNulty discloses a large high horsepower gas operated concrete cutting chain saw having an elaborate water dispersing means to facilitate chain cooling and the removal of cut material. Specifically, McNulty specifies using a saw chain having cutting teeth 0.75 inches in length, a chain surface speed of 2,800 feet per minute, and a bar run of 3 feet in order to achieve a steel reinforced concrete cutting rate of 24 in²/minute. To achieve this performance with the specified parameters, the power unit of McNulty would need to be at least a 6 horsepower gas motor or about a 10 horsepower electric motor (which would not run on typical single phase household electrical current), both of which are considered high horsepower power heads.

Because some jobs do not require the same cutting rate and durability required of the industrial/commercial cutters, applicant has been able to achieve a concrete cutting chain saw that may run on standard single phase electrical current, and still be able to appreciably cut concrete.

### BRIEF DESCRIPTION OF THE INVENTION

As previously discussed to achieve cutting in the aforementioned user types (contractor to professionals), the chain speed has been kept generally lower and torque kept higher, thus necessitating a higher horsepower motor (i.e. greater than 4 horsepower). Thus, when it became apparent that there was inadequate torque to perform the cutting operation, it was assumed that single phase electrical current, e.g., household current, was inadequate to provide the horsepower demands for a concrete cutting tool, e.g., a concrete cutting chain saw.

Embodiments of the present invention include an electric concrete cutting chain saw that can be operated by a low horsepower power head on a single phase household electric power source. It has been found that this may be achieved by altering the speed and torque requirements beyond the conventional thinking in order to accommodate the limits of the power source, i.e. the electrical power output of single phase electricity commonly found in a home.

Whereas it was found that the torque cannot be reduced significantly to achieve that end, embodiments in accordance with the invention challenges the prevailing view as to the torque and chain speed requirements, which necessitates the high power input requirements. In various embodiments, the surface speed was modified via a modification in size of the drive sprocket. It has been found that some increase in chain speed was acceptable and surprisingly enabled the retention of sufficient torque to satisfy less severe concrete cutting demands, all at a horsepower requirement achievable with single phase electric power.

In various embodiments it has been found that using a low horsepower motor ( i.e. less than about 2500 watts input) in combination with chain speeds in the range of 3,500 feet per minute to about 5,500 feet per minute may be effective at achieving sufficient torque that can result in the cutting of concrete in an appreciable manner. In further embodiments, the chain speed ranges from about 4000 to 5000 feet per minute. Yet in other embodiments, the speed ranges from about 4500 to 4800 feet per minute.

It has also been found that in various embodiments, sufficient torque may be achieved and/or enhanced even with the increased chain speeds over the traditional chain speeds, and yet require a lower power input by narrowing of the chain and bar width in order to produce a narrower kerf to be cut. In various embodiments, the cutter segment width, which generally dictates the kerf width, may be less than or equal to about 0.225 inches. In various embodiments, the bar and/or the overall width of the components that support the cutter segment may be less than about 0.225 inches.

In various embodiments, it has further been found that reducing the number and/or density of the abrasive chips (cutting implements) in the cutting segments of the saw chain cutters, which reduces the number of diamonds or abrading elements that participate in the cutting action at any given time. While this in and of itself may not reduce the torque, it may alter the torque requirements such as to support the usage of a lower power input cutting device. Accordingly, in various embodiments the chain speed may be increased beyond conventional wisdom in order to enhance the cutting rate by increasing the interface frequency of the abrasive chips and the concrete being cut. In some embodiments, the range of abrasive chip density may range from 5% to 35% of the cutter segment makeup. Such a make up is a departure from the conventional cutting segment density in higher horsepower units, which are known to generally range from 35% and higher.

Whereas the cutting saw set forth herein may not cut concrete at a rate comparable with the industrial size concrete cutting saws, what can occur is the matching of the cutting capabilities of the saw to the power capabilities of a single phase electrical power source. Such provides the homeowner or casual user with an affordable, smooth running and efficient electric powered concrete cutting tool that has not been heretofore considered achievable as a homeowner type tool.

### BRIEF DESCRIPTION OF DRAWINGS

FIGS. 1 and 2 illustrate various views of a concrete cutting saw and chain in accordance with various embodiments of the present invention;

FIG. 3A illustrates a view of the cutting segment and bar of a concrete cutting chain saw in accordance with various embodiments of the invention; and

FIG. 3B illustrates a side view of a cutter segment in accordance with various embodiments of the present invention.

### DESCRIPTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B and C).” For the purposes of the present invention, the phrase “(A)B” means “(B) or (AB)”, that is, A is an optional element.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

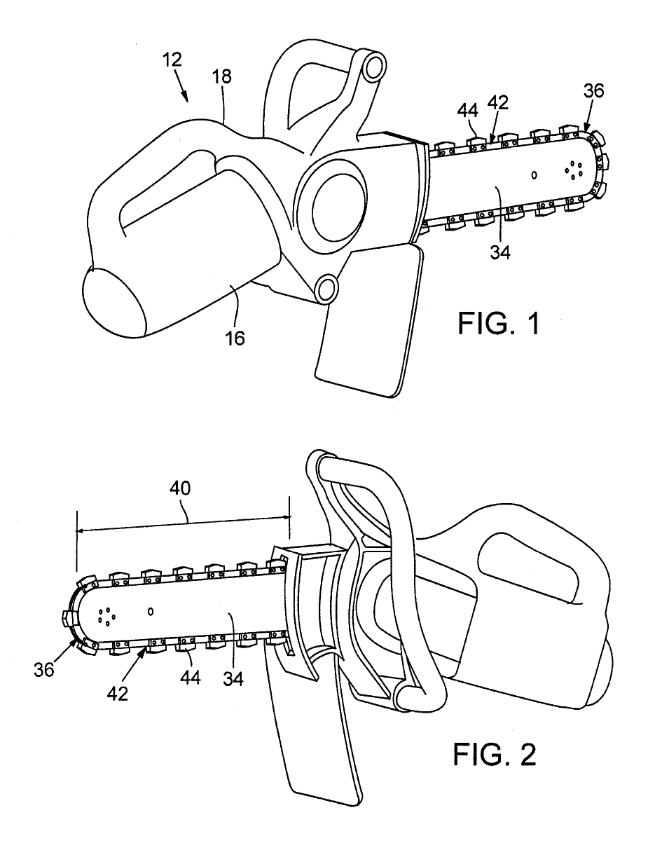

FIGS. 1 and 2 illustrate an electric concrete cutting chain saw in accordance with embodiments of the present invention. The chain saw includes a power head 12, having a body 16 and a handle portion 18. A low horsepower electric motor may be disposed inside the body 16, and adapted to couple to a single phase electric outlet via a cord (not shown). The electric motor through actuation of the trigger switch 21 rotatably drives a drive shaft coupled to a drive sprocket.

A concrete cutting saw chain 42 may be coupled to a guide bar 34 so as to be guided on the periphery of the guide bar 34 and nose sprocket 36. The chain 42 is thus driven by the drive shaft and drive sprocket around the guide bar. Saw chain 42 may have a plurality of cutter segments 44 which may be impregnated with abrasive elements such as diamond chips to aid in the abrading and thus cutting of concrete.

The inventors departed from the conventional wisdom and conceived the idea that horsepower could be reduced by balancing the chain speed with an acceptable torque level. The smaller saw and the type and frequency of concrete cutting by e.g. a homeowner renders speed of cutting less important. As the potential power input is limited, it has been found that balancing the chain speed with the horsepower input in order to maximize or at least improve the resulting torque results in a saw that can appreciably cut concrete (e.g. at a rate of greater than 5 in² per minute) while using a low horsepower motor, or accommodating the limited power input from typical household outlets.

In various embodiments power head 12 may include a low horsepower motor (i.e. adapted to operate off less than about 2500 watts input), such as less than 4 horsepower, in combination with chain speeds that fall within the range of about 3,500 feet per minute to about 5,500 feet per minute. Such a configuration has been found to be an effective combination for cutting concrete in an appreciable manner. In further embodiments, the chain speed may range from 4000 to 5000 feet per minute. Yet in other embodiments, the speed ranges from 4500 to 4800 feet per minute.

In one embodiment, it was determined that a chain speed of about 4,800 feet/minute allowed use of a low horsepower power head 12 and yet generated a sufficient amount of torque for cutting concrete. These unexpected results are a byproduct of the favorable matching of speed, available power input, and torque of the saw to the less abusive jobs of the homeowner or casual user. In various embodiments, as the horsepower is reduced from the upper end of the low horse power range, the chain speed may be increased to facilitate/maintain appreciable cutting of concrete.

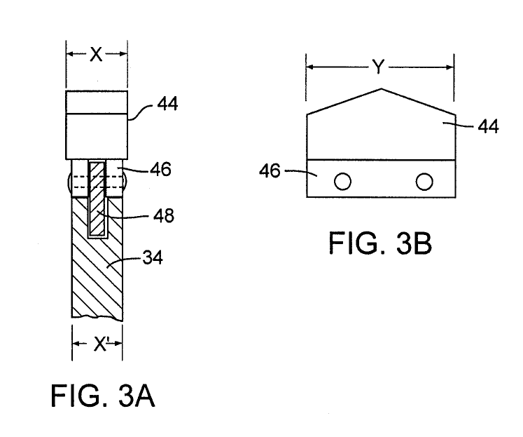

In various embodiments, the cutting links may be made smaller (e.g. narrower and/or shorter), which in turn reduces the kerf width. Reducing the kerf width may help reduce the torque and power demands, while allowing the cutting segments to appreciably cut concrete. As illustrated in FIG. 3A, chain segment 44 may have a width X, which in various embodiments may be less than or equal to about 0.225 inches. It has been found that such a width helps enable the use of a low power head, and yet achieve appreciable cutting rates. In various embodiments, the narrowing of cutter segments alone may enable the use of low horsepower power heads. In further embodiments, the width of the chain components supporting the cutter segment 44, as well as the bar 34 may be the same width X or narrower as desired.

Similarly, as illustrated in FIG. 3B, the length Y of the cutter segment 44 may be reduced beyond the traditional cutter segment length. In one embodiment, the length Y may be less than or equal to 0.25 to 0.6 of an inch. In various embodiments, the length of the bar 34 may also be less than or equal to about eighteen inches, there by reducing the load demands on the power head.

In various embodiments, the number and/or amount of exposed abrasive chips/elements on a cutting segment at any given point in the wear cycle may reduce the resistance and thus the torque demand. This may in turn help enable the use of a lower horsepower power head in accordance with embodiments of the invention. In various embodiments, the abrasive chip/element density may be in the range of about 5% to 35% of the cutter head 42. It has further been found that while the reduction in density results in a lower torque requirement, it also may allow for a faster chain speed in order to improve the cutting effectiveness of the lower density segments.

Again, embodiments of the present invention are contrary to conventional wisdom, which has been to focus on high torque, and thus high power as the most important aspect of effectively cutting concrete. Accordingly, the chain speeds had to be kept lower (e.g. 2800 feet per minute) in such high horsepower environments in order to achieve/maintain the desired torque needed to achieve the cutting rates that are desirable. Now, as a result of various embodiments, the homeowner can power the saw with single phase household current or a low horsepower gas power head and achieve a smooth yet adequate cutting performance at a cost that is a fraction of that required for the higher powered industrial/professional cutting tools.

The interrelationship of these changes has produced a unique concrete cutting chain saw that provides a desirable match up to the needs of a typical homeowner having concrete cutting tasks. Those skilled in the art will conceive of further alterations and variations without departing from the invention. Accordingly, the above disclosed embodiment is included as an example of but one embodiment, albeit a preferred embodiment, of the invention. The invention is not to be limited to that of the disclosure but is intended to be encompassed by the definition of the claims appended hereto, the terms of which are to be given a broad interpretation as used in the art.

1. A concrete cutting chain saw comprising:
a low horsepower power head adapted to be driven by a power input available from a single phase power source;
a guide bar coupled to the power head
a concrete cutting chain mounted on the guide bar and adapted to be driven around the guide bar, the concrete cutting chain having a plurality of cutter segments;
said power head configured to generate a surface speed for the cutting chain of a range between about 3500 feet per minute and 5500 feet per minute.

2. The concrete cutting chain saw of claim 1, wherein the chain surface speed is in the range of about 4000 to 5000 feet per minute.

3. The concrete cutting chain saw of claim 1, wherein the chain surface speed is in the range of about 4500 to 4800 feet per minute.

4. The concrete cutting chain saw of claim 1, wherein the low horsepower cutting head is less than 4 horsepower.

5. The concrete cutting chain saw of claim 1 wherein the power head is configured to operate on a maximum power input of 2500 watts.

6. A concrete cutting chain saw as defined in claim 1 wherein the maximum width of any one cutting segment is less than or equal to about 0.225 inches.

7. A concrete cutting chain saw as defined in claim 1 wherein the cutter segments have an abrasive element density of between 5% and 35%.

8. A concrete cutting chain saw as defined in claim 1 wherein the bar length is less than or equal to 18 inches.

9. A concrete cutting chain saw comprising:
a low horsepower power head adapted to be driven by a power input available from a single phase power source, the power input being less than or equal to about 2500 watts;
a guide bar coupled to the power head having a length of less than or equal to about 18 inches;
a concrete cutting chain mounted on the guide bar and adapted to be driven around the guide bar by a drive sprocket driven by the power head, the concrete cutting chain having a plurality of cutter segments, the cutter segments having a width of less than or equal to about 0.225 inches and an abrasive element density of between about % 5 and 35%;
wherein said sprocket and power head are cooperatively configured to provide a surface speed for said cutting chain in the range of about 3500 to 5500 feet per minute while maintaining sufficient torque to drive the chain at the desired surface speed sufficient to cut concrete at a rate of greater than or equal to 5 in² per minute.

10. A concrete cutting saw chain adapted for use on a concrete cutting chain saw, comprising:
a plurality of cutting segments having a mix of abrasive elements and generally non abrasive material, the cutting segments having a width of less than or equal to about 0.225 inches and an abrasive element density of between % 5 and 35%.
